(19) United States
(12) Patent Application Publication
(10) Pub. No.: US 2022/0284526 A1
(43) Pub. Date: Sep. 8, 2022

(54) Protocol Selection and Enforcement During Remote Online Notarization Session

(71) Applicant: DocuSign, Inc., San Francisco, CA (US)

(72) Inventors: Alexander Hardy, Austin, TX (US); Allan Keller, Austin, TX (US); Peter Rung, Austin, TX (US)

(21) Appl. No.: 17/190,035

(22) Filed: Mar. 2, 2021

(51) Int. Cl. G06Q 50/18; G06N 20/00; H04L 29/08

(52) U.S. Cl. CPC G06Q 50/18; G06N 20/00; H04L 67/141

(57) ABSTRACT

A system and a method are disclosed where a server receives a request to establish a remote online notarization session. The server identifies participants including at least a signer and a notary and identifies identifying an envelope to be notarized during the remote online notarization session. The server determines, based on contents of the envelope, parameters of the remote online notarization session, and selects a protocol to which the remote online notarization session will conform. The system establishes the remote online notarization session using the protocol, and determines, while monitoring the session, whether the protocol was breached by at least one of the signer and the notary. If the protocol was breached, the server re-starts the remote online notarization session, otherwise the server the remote online notarization session, and outputs a notarized version of the envelope.

### TECHNICAL FIELD

The disclosure generally relates to the field of secure electronic documents, and more particularly relates to selecting protocols for facilitating a remote online notarization session with relation to a secure electronic document.

### BACKGROUND

Remote online notarization sessions enable signers of documents to have a document signed and notarized electronically, thus providing convenience in eliminating a need to physically visit a notary in order to have a document notarized. Different types of secure electronic documents are subject to different rules regarding what forms a valid notarization of a document. Yet further, remote online notarization poses challenges that do not exist in a physical notarization scenario, in that hardware, bandwidth, and other processing limitations may render a notarization session ineffective where these limitations render a notary unable to perform its function (e.g., properly verify identity of a signer).

### SUMMARY

Systems and methods are disclosed herein that render dynamically determine workflow for a remote online notarization session based on the detection of certain conditions. The workflow may be determined based on a protocol selected for the remote online notarization session, the protocol being dynamically selected based on, for example, the parameters of an envelope being notarized during the session. Protocols may have different tolerances, where, for example, a one-second network connection failure of a device may be tolerated when one protocol is used, but may not be tolerated when another protocol is used. Where a protocol is breached during a remote online notarization session, a curing activity may be performed (e.g., re-starting the session from the beginning).

In an embodiment, a server receives a request to establish a remote online notarization session. The server identifies participants of the remote online notarization session, the participants including at least a signer and a notary, and identifies an envelope to be notarized during the remote online notarization session. The server determines, based on contents of the envelope, parameters of the remote online notarization session, and selects, based on at least one of the participants and the parameters of the remote online notarization session, a protocol to which the remote online notarization session will conform. The server establishes the remote online notarization session using the protocol.

The server monitors the remote online notarization session. Based on the monitoring, the server determines whether, during the remote online notarization session, the protocol was breached by at least one of the signer and the notary prior to signature of the envelope by the signer and notarization. Responsive to determining that the protocol was breached, the server re-starting the remote online notarization session. Responsive to determining that the protocol was not breached, the server validates the remote online notarization session, and outputs a notarized version of the envelope.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one embodiment of a system environment for operating a remote online notarization service.

FIG. 2 illustrates one embodiment of exemplary modules and databases used by the remote online notarization service.

FIG. 3 is a block diagram illustrating components of an example machine able to read instructions from a machine-readable medium and execute them in a processor (or controller).

FIG. 4 is an exemplary flowchart showing a data flow for operating a remote online notarization service to select and validate compliance with a protocol for use in a remote online notarization session.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Remote Online Notarization Service System Environment

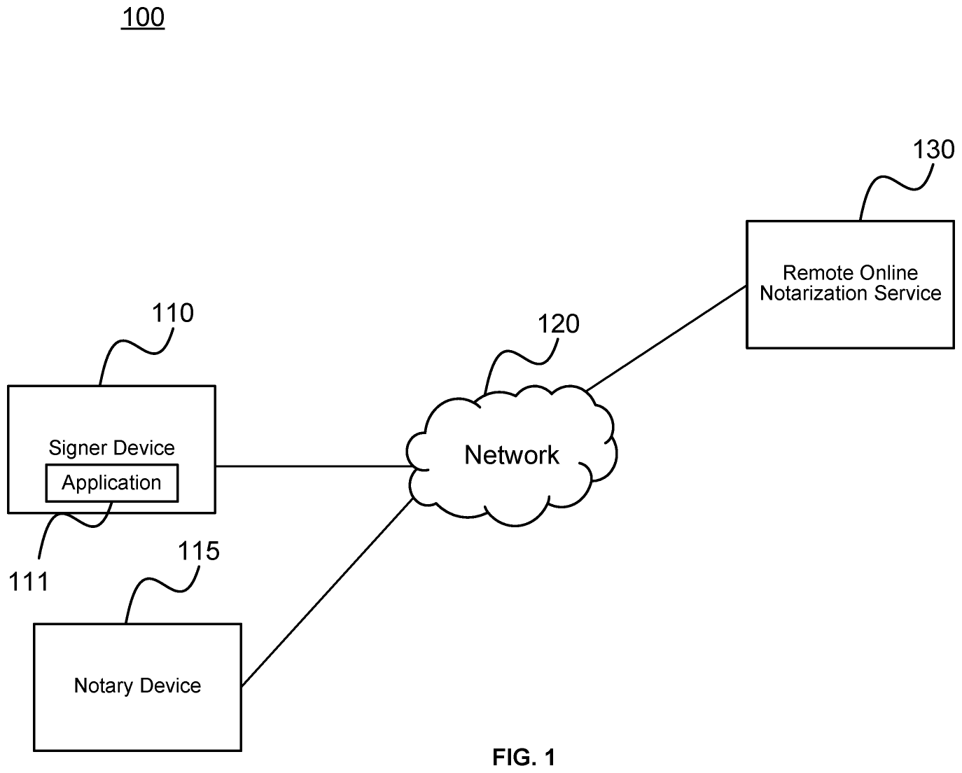

FIG. 1 illustrates one embodiment of a system environment for operating a remote online notarization service. Environment 100 includes signer device 110 with application 111 installed thereon, notary device 115, network 120, and remote online notarization service 130. Signer device 110 and notary device 115 are client devices. The elements of environment 100 are exemplary only, and more or fewer elements may be implemented without departing from the scope of the disclosure.

Environment 100 includes various client devices, such as signer device 110 (with application 111 installed thereon) and notary device 115. The client devices communicate with remote online notarization service 130 through network 120. The term client device, as used herein, may refer to a computing device such as smartphones with an operating system such as ANDROID® or APPLE® IOS®, tablet computers, laptop computers, desktop computers, electronic stereos in automobiles or other vehicles, or any other type of network-enabled device from which secure documents may be accessed or otherwise interacted with. Typical client devices include the hardware and software needed to input and output sound (e.g., speakers and microphone) and images, connect to the network 120 (e.g., via Wifi and/or 4G or other wireless telecommunication standards), determine the current geographic location of the client devices 100 (e.g., a Global Positioning System (GPS) unit), and/or detect motion of the client devices 100 (e.g., via motion sensors such as accelerometers and gyroscopes).

Signer device 110 is operated by a signer of an envelope. The term signer, as used herein, may refer to a person who is to apply a signature to one or more secure documents in an envelope. The term signature, as used herein, may refer to any notation whereby the signer acknowledges a provision in the envelope. Example signatures may include a signing of one's full name, initials, or any other form of acknowledgment whether or not the signature identifies the signer (that is, includes less than a full name of a signer, or includes a name but in illegible form). A secure document (sometimes referred to herein as a “document”) is an electronic document with security encoded in association therewith to ensure integrity of the document. An example of a secure document is a document for signature by a user of signer device 110, where the document is unable to be modified by the user other than to add signatures to the document. Secure documents need not be signature documents, and may be any document that has security features that limit activity of a receiving user and/or otherwise use features that ensure the integrity of the documents. The term envelope, as used herein, may refer to a collection of one or more associated secure documents. For example, an envelope may include several secure documents, some or all of which may require signature and/or notarization in order to be validated. While only one signer device is depicted in environment 100, any number of signer devices may be present (e.g., where multiple signers are required in order to complete an envelope).

Signer device 110, as depicted, has application 111 installed thereon. Any or all client devices in environment 100 may have application 111 installed thereon. Application 111 may be a stand-alone application downloaded by a client device from secure document service 130. Alternatively, application 111 may be accessed by way of a browser installed on the client device, accessing an application instantiated from secure document service 130 using the browser. In the case of a stand-alone application, browser functionality may be used by application 111 to access certain features of secure document service 130 that are not downloaded to the client device. Application 111 may be used by a client device to perform any activity relating to a secure document, such as to create, design, assign permissions, circulate, access, sign, notarize, modify, add pictorial content, and so on.

Notary device 115 is a client device operated by a notary. The term notary, as used herein, may refer to a person authorized to validate a secure document. The authorization may be bestowed upon the notary by a relevant agency (e.g., a government agency in a jurisdiction in which the notary resides or works, or which pertains to the envelope to be notarized). Notarization refers to any form of validation, including apostille and any other form of legalization of a secure document.

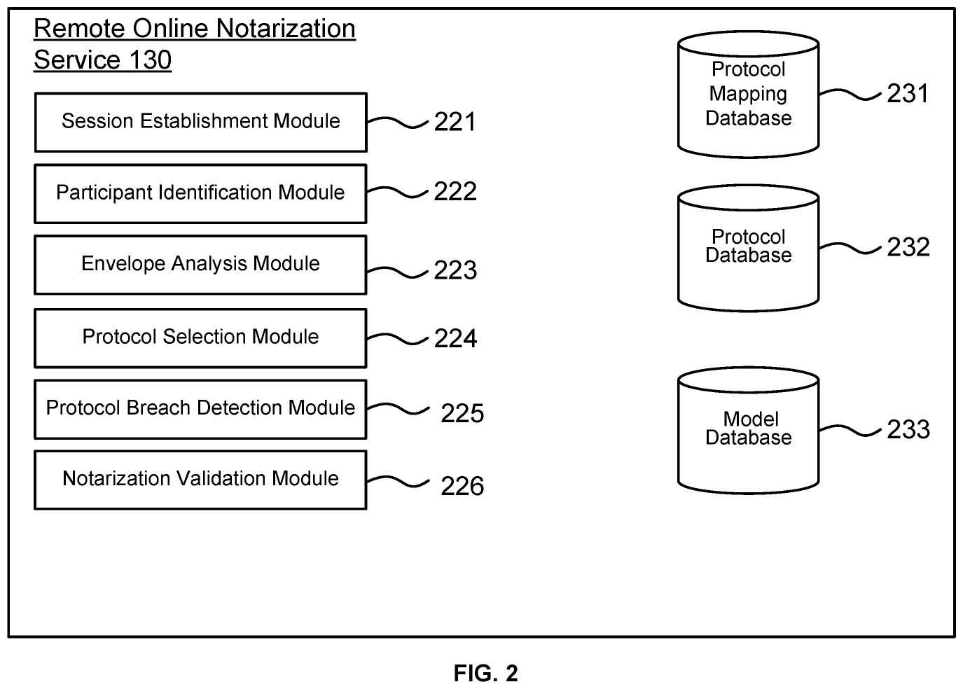

Remote online notarization service 130 facilitates a notarization of an envelope during a notarization session. Where an envelope is successfully notarized, remote online notarization service 130 validates the envelope. Remote online notarization service 130 applies one or more protocols that, if breached, would cause a notarization of an envelope to fail or not act to validate the envelope. Details of operation of remote online notarization service 130 are further described below with reference to FIG. 2.

FIG. 2 illustrates one embodiment of exemplary modules and databases used by the remote online notarization service. As depicted in FIG. 2, notarization service 130 includes session establishment module 221, participant identification module 222, envelope analysis module 223, protocol selection module 224, protocol breach detection module 225, notarization validation module 226, protocol mapping database 231, protocol database 232, and model database 233. The modules and databases depicted in FIG. 2 are merely exemplary; fewer or more modules and databases may be used by notarization service 130 to achieve the activity described herein. Moreover, while notarization service 130 is depicted as a stand-alone entity, functionality of notarization service 130 may be distributed across multiple servers and/or may be implemented in part or in whole by application 111 of one or more client devices.

Session establishment module 221 establishes a remote online notarization session (interchangeably referred to herein simply as a “session”) between participants. The term participant, as used herein, may refer to any person present in a remote online notarization session. This may include, but is not limited to, a signer, a notary, and a witness. The term witness, as used herein, may refer to a person who signs a secure electronic document, but is distinguished from a signer in that the witness may be any qualifying person, whereas the signer is a particular person that is party to the secure electronic document and cannot be substituted with another signer absent exceptional circumstances (e.g., an agent of the signer is authorized to sign on behalf of the signer). The term remote online notarization session as used herein may refer to a session in which participants are present, and where a protocol is established for validating a notarization of a signature on at least a portion of an envelope.

In an embodiment, session establishment module 221 establishes a session responsive to receiving a request to establish the session. The request may be received from the notary, the signer, or a third party (e.g., witness). Establishing a session may include any activity leading up to the remote online notarization session beginning. This activity may include identifying the participants of the session (e.g., as performed using participant identification module 222, described below), selecting one or more protocols to be applied to the session (e.g., described with respect to protocol selection module 222 below), and any other related activity. Activity relating to establishing and running a remote online notarization session is described in further detail in commonly owned patent application Ser. No. 17/039,348, filed Sep. 30, 2020, the disclosure of which is hereby incorporated by reference herein in its entirety. After the session is established, the remote online notarization session begins, and a signing and notarization process may occur within the session.

Participant identification module 222 identifies participants to a remote online notarization session. While some participants are identified prior to establishing a remote online notarization session, additional participants may be identified during the remote online notarization session (e.g., where additional or replacement notaries or witnesses are required). In an embodiment, participant identification module 222 automatically identifies the user who operates the client device that requested to establish the remote online notarization session as a participant. The requesting user is typically a signer, but may be a notary, witness or third party. Participant identification module 222 may command application 111 to display a prompt to the requesting user to identify one or more additional participants. The prompt may include a generic field (e.g., a prompt to enter email addresses for other participants), where input received via the prompt results in requests being output to other participants to join the session, that, when accepted, cause participant identification module 222 to identify the accepting users as participants. The prompt optionally includes one or more selectable options that enable the requesting user to specify the role of each identified additional participant (e.g., co-signer, notary, witness). The term co-signer, as used herein, may refer to one or more additional signers, relative to the requesting user, who are indicated in the envelope as required to sign the envelope for the envelope to be completed.

In an embodiment, participant identification module 222 automatically identifies candidate participants associated with the requesting user and/or the document. Participant identification module 222 may access a profile of the requesting user, and may determine therefrom an association to candidate participants. For example, participant identification module 222 may determine that the user is associated with a certain conglomerate, and may identify notaries and/or witnesses associated with that conglomerate. In such an embodiment, participant identification module 222 may include in a prompt to the requesting user selectable options to invite the associated candidate participants to the session, where the user may select which of the candidates to select. Alternatively, participant identification module 222 may automatically select one or more candidates depending on the needs of the session (e.g., one or more notaries and/or witnesses), and based on parameters reflected in the profiles of the candidates (e.g., availability of the candidates indicated in a data structure lining up with a date and time indicated for the remote online notarization session). Regardless, participant identification module 222 may transmit invitations to selected candidates that, when accepted, cause participant identification module 222 to identify the accepting candidate as a participant of the session.

Participant identification module 222 may identify participants automatically based on content of the envelope to be notarized during the session. For example, the envelope may indicate names of persons responsible for signing one or more portions of the envelope, and may automatically identify electronic communications addresses (e.g., email addresses, telephone numbers, etc.) and use those addresses to transmit requests to those persons to join the session as participants. Participant identification module 222 may additionally, or alternatively, identify generic parameters for the session (e.g., that a certain number of witnesses are required), and transmit requests to arbitrary persons (e.g., candidate witnesses) based on parameters of those candidates' profiles.

In an embodiment (e.g., where the signer is not the requesting user), participant identification module 222 may automatically identify one or more signers. Participant identification module 222 may determine, based on information of the envelope itself, which parties are named as signers. Participant identification module 222 may access user profiles of the identified one or more signers, and may transmit a request to the signers to join the session as participants. Responsive to receiving an acceptance of the request, participant identification module 222 may identify those one or more signers as participants of the remote online notarization session.

Envelope analysis module 223 identifies an envelope to be notarized during the remote online notarization session. The requesting user may identify the envelope as part of initiating the request to establish the remote online notarization session (e.g., by attaching the envelope, or by pointing to a memory address associated with the envelope). Envelope analysis module 223 may analyze the envelope to determine parameters of the remote online notarization session. Analyzing the envelope may include an analysis of the contents of the envelope (e.g., the textual and pictorial content within the secure electronic documents that form the envelope) and/or metadata of the envelope.

In an embodiment, envelope analysis module 223 determines a value associated with the envelope. The value may be absolute, or may be relative to values of other known envelopes (e.g., ranking using discrete categorizations of value such as high, medium, low, or on a continuous numerical scale). Envelope analysis module 223 may determine the value by directly extracting the value from the contents of the envelope. Alternatively, envelope analysis module 223 may determine the value associated with the envelope by inputting at least a portion of the contents into a machine learning model (e.g., retrieved from model database 233), and receiving, as output from the machine learning model, a value. The machine learning model may be trained using training data that labels keywords, or collections of keywords (e.g., keywords that are found within a certain distance of one another, or within a same grammar structure such as a paragraph), or a combination thereof with an indication of value. For example, keywords associated with an acquisition of a conglomerate by another conglomerate may be paired with a label indicating that this is a high stakes envelope, and keywords associated with an acquisition of a toy may be paired with a label indicating that this is a low stakes envelope. Envelope analysis module 223 may determine the value to be a parameter of the envelope.

Envelope analysis module 223 may determine one or more locations associated with the envelope. Similar to a value determination, envelope analysis module 223 may determine a location by directly extracting the location, or by inputting the envelope or a portion thereof into a machine learning model, and receive an output of the location. The model may be similarly trained using training data that pairs keywords with a label indicating an associated location. For example, keywords in a certain language (e.g., French) that are associated with a certain dialect may be labeled with a corresponding country and/or region within a country, thus enabling the machine learning model to output locations associated with content of the envelope. Additional signals may be used, such as metadata of the envelope and/or of data packets associated with participants (e.g., an Internet Protocol address may be used to identify location of a given participant, either directly or as an additional signal to the machine learning model).

Envelope analysis module 223 may determine parameters of the session to include locations themselves and/or information associated with those locations, such as regulatory rules that apply in those locations. As an example, where a location is determined, envelope analysis module 223 may identify notarization rules that apply to that location based on entries of a database that maps locations to such rules, such as a requirement in a country that one witness or two witnesses are required.

Protocol selection module 224 selects one or more protocols to apply to the remote online notarization session. The term protocol, as used herein, may refer to a set of requirements to which the remote online notarization must conform in order to be validated. Protocols may dictate requirements for any aspect of a remote online notarization session, such as technical (e.g., hardware, memory, and network bandwidth requirements for each participant of the session), identity verification requirements (e.g., a level of rigor to be used in verifying an identity of a signer), participation requirements (e.g., a level of credential needed and/or a number of notaries and/or witnesses required), regulatory requirements (e.g., a requirement that a document be apostilled), and so on.

In an embodiment, protocol selection module 224 compares the parameters to entries of protocol mapping database 231. Protocol mapping database 231 maps parameters to corresponding protocols. For example, different values may be associated with different protocols, where high values might correspond to heightened technical requirements, identity verification requirements, and/or participant requirements, whereas lower values may correspond to lower such requirements. With respect to technical requirements, lower requirements may tolerate, for example, a breach of a requirement that lasts for less than a threshold amount of time (e.g., a microphone is muted for less than five seconds, a network connection is below a threshold quality for less than a second, and so on). With respect to identity verification requirements, lower requirements may allow for a less rigorous or a manual identity verification by the notary, whereas higher requirements might require more rigorous or additional identity verification processes. With respect to participant requirements, lower requirements may allow participants (e.g., co-signers, witnesses, etc.) to sign in counterpart envelopes, or in different separate remote online notarization sessions, whereas higher requirements may require the participants to sign in a same envelope and/or during a same session. Responsive to identifying one or more protocols that maps to the parameters, protocol selection module 224 selects the one or more protocols for use in the remote online notarization session, and may return an identifier of the protocol for those protocol(s) to session establishment module 221. Session establishment module 221 may use the selected protocol(s) to select requirements that conform to those protocols for the established remote online notarization session. Those requirements may be retrieved from protocol database 232 based on the returned protocol identifier(s).

Protocol breach detection module 225 monitors the remote online notarization session based on the requirements of the one or more protocols, and determines whether the protocol was breached by at least one of the signer and the notary. Protocol breach detection module 225 determines that a protocol is breached where a requirement of the selected protocol(s) is not met (or is not met for a requisite amount of time). Where a requirement is not met, protocol breach detection module 225 determines that the protocol was breached.

In an embodiment, responsive to determining that the protocol was breached, protocol breach detection module 225 commands session establishment module 221 to re-start the remote online notarization session. Alternatively, responsive to determining breach, protocol breach detection module 225 may initiate a cure procedure. Whether to re-start the remote online notarization session or to initiate a cure procedure may be determined based on whether the protocol requirements include a requirement to restart, or a requirement to initiate a cure procedure.

A cure procedure may be active or passive on the part of the signer and/or the notary. Where a technological requirement is not met, thus causing the breach, the cure procedure may be to determine whether the technological requirement is again met within a threshold amount of time. The threshold amount of time may vary depending on the parameters (e.g., with a lower amount of time to cure where the value corresponding to the session is high, and with a higher amount of time to cure where the value corresponding to the session is low). Thus, for example, where a camera of the signer and/or the notary is disabled during the session, a cure procedure may enable the user of the camera to re-enable the camera within the corresponding amount of time.

In an embodiment, the breach may be an inability of the signer to successfully verify their identity. Where a cure procedure is available, the cure procedure may enable the notary to override the identity verification requirement. In an embodiment, the availability of such a cure procedure may selectively be made available depending on an association between the notary and the signer. For example, protocol breach detection module 225 may determine, based on a profile of the notary, whether the notary personally knows the signer. Responsive to determining that the notary personally knows the signer, protocol breach detection module 225 may enable this cure procedure, but otherwise may disable such a cure procedure. An alternative cure procedure may be for the notary to manually verify the identity of the signer (e.g., through a predefined process).

Notarization validation module 226 determines whether the remote online notarization session concluded successfully. The determination may be based on the signer and notary (and other participants, where required) having successfully signed the envelope without a protocol breach. Responsive to determining that the protocol was not breached before the participants have satisfied the signature requirements of the session, notarization validation module 226 validates the remote online notarization session, and outputs a notarized version of the envelope. The notarized version may be a secure, read-only version of the envelope that includes the signatures of the participants.

### Computing Machine Architecture

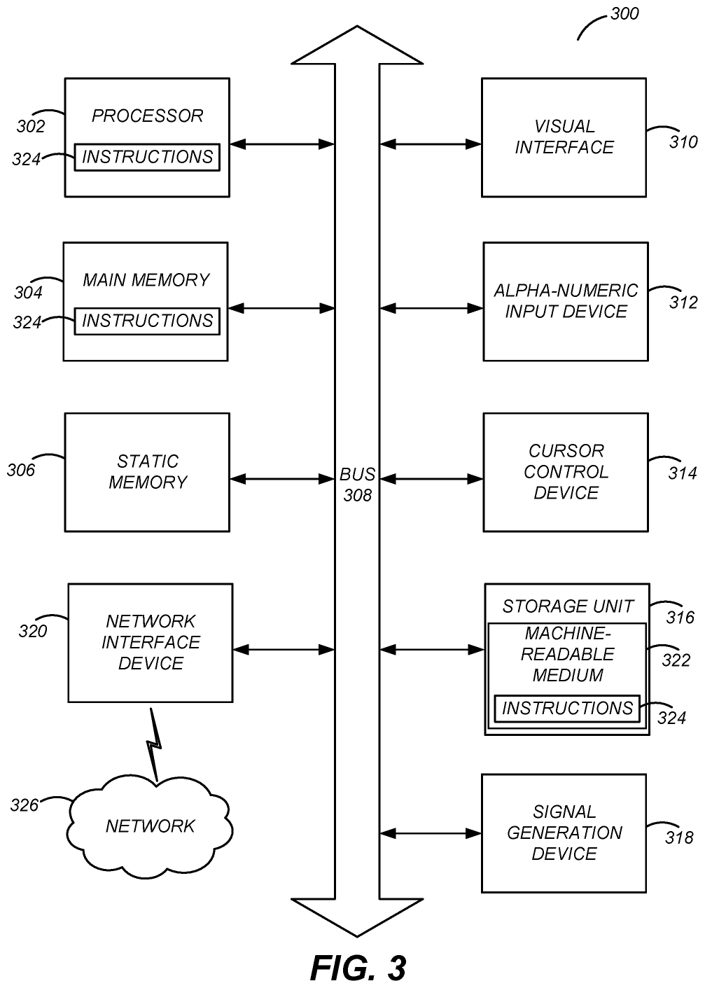

FIG. 3 is a block diagram illustrating components of an example machine able to read instructions from a machine-readable medium and execute them in a processor (or controller). Specifically, FIG. 3 shows a diagrammatic representation of a machine in the example form of a computer system 300 within which program code (e.g., software) for causing the machine to perform any one or more of the methodologies discussed herein may be executed. The program code may be comprised of instructions 324 executable by one or more processors 302. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 324 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 300 includes a processor 302 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 304, and a static memory 306, which are configured to communicate with each other via a bus 308. The computer system 300 may further include visual display interface 310. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 310 may include or may interface with a touch enabled screen. The computer system 300 may also include alphanumeric input device 312 (e.g., a keyboard or touch screen keyboard), a cursor control device 314 (e.g., a mouse, a trackball, a joystick, a motion sensor, or other pointing instrument), a storage unit 316, a signal generation device 318 (e.g., a speaker), and a network interface device 320, which also are configured to communicate via the bus 308.

The storage unit 316 includes a machine-readable medium 322 on which is stored instructions 324 (e.g., software) embodying any one or more of the methodologies or functions described herein. The instructions 324 (e.g., software) may also reside, completely or at least partially, within the main memory 304 or within the processor 302 (e.g., within a processor's cache memory) during execution thereof by the computer system 300, the main memory 304 and the processor 302 also constituting machine-readable media. The instructions 324 (e.g., software) may be transmitted or received over a network 326 via the network interface device 320.

While machine-readable medium 322 is shown in an example embodiment to be a single medium, the term “machine-readable medium” should be taken to include a single medium or multiple media (e.g., a centralized or distributed database, or associated caches and servers) able to store instructions (e.g., instructions 324). The term “machine-readable medium” shall also be taken to include any medium that is capable of storing instructions (e.g., instructions 324) for execution by the machine and that cause the machine to perform any one or more of the methodologies disclosed herein. The term “machine-readable medium” includes, but not be limited to, data repositories in the form of solid-state memories, optical media, and magnetic media.

### Exemplary Protocol Selection and Breach Detection Process

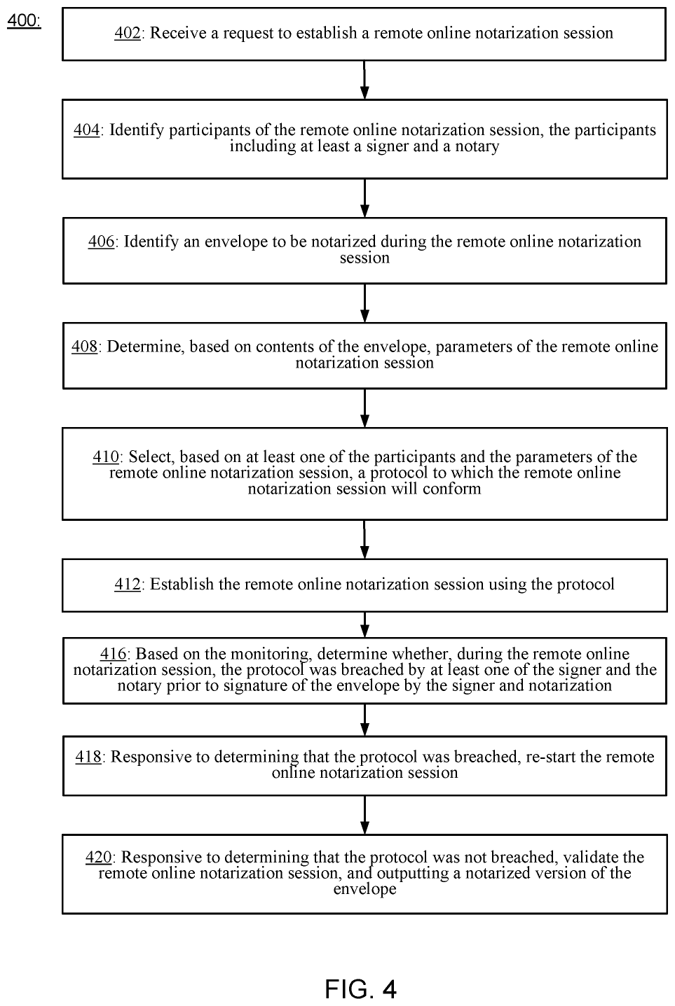

FIG. 4 is an exemplary flowchart showing a data flow for operating a remote online notarization service to select and validate compliance with a protocol for use in a remote online notarization session. Process 400 begins with remote online notarization service 130 receiving 402 a request to establish a remote online notarization session. Remote online notarization service 130 identifies 404 participants of the remote online notarization session (e.g., using participant identification module 222), the participants including at least a signer and a notary. Remote online notarization service 130 identifies 406 an envelope to be notarized during the remote online notarization session (e.g., using envelope analysis module 403).

Remote online notarization service 130 determines 408, based on contents of the envelope, parameters of the remote online notarization session, and selects 410, based on at least one of the participants and the parameters of the remote online notarization session, a protocol to which the remote online notarization session will conform (e.g., using protocol selection module 224). Remote online notarization service 130 establishes 412 the remote online notarization session using the protocol (e.g., using session establishment module 221). Remote online notarization service 130 monitors 414 the remote online notarization session, and, based on the monitoring, determines 416 whether, during the remote online notarization session, the protocol was breached by at least one of the signer and the notary prior to signature of the envelope by the signer and notarization.

Responsive to determining that the protocol was breached, remote online notarization service 130 re-starts 418 the remote online notarization session. Responsive to determining that the protocol was not breached, remote online notarization service 130 validates 420 the remote online notarization session, and outputs a notarized version of the envelope.

### ADDITIONAL CONFIGURATION CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for implementing a remote online notarization service through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
receiving a request to establish a remote online notarization session;
identifying participants of the remote online notarization session, the participants including at least a signer and a notary;
identifying an envelope to be notarized during the remote online notarization session;
determining, based on contents of the envelope, parameters of the remote online notarization session;
selecting, based on at least one of the participants and the parameters of the remote online notarization session, a protocol to which the remote online notarization session will conform;
establishing the remote online notarization session using the protocol;
monitoring the remote online notarization session;
based on the monitoring, determining whether, during the remote online notarization session, the protocol was breached by at least one of the signer and the notary prior to signature of the envelope by the signer and notarization;
responsive to determining that the protocol was breached, re-starting the remote online notarization session; and
responsive to determining that the protocol was not breached, validating the remote online notarization session, and outputting a notarized version of the envelope.

2. The method of claim 1, wherein determining, based on the contents of the envelope, the parameters of the remote online notarization session comprises determining, from the contents of the envelope, a value associated with the envelope.

3. The method of claim 2, wherein determining the value associated with the envelope comprises extracting the value from the contents.

4. The method of claim 2, wherein determining the value associated with the envelope comprises:
inputting at least a portion of the contents into a machine learning model; and
receiving, as output from the machine learning model, the value.

5. The method of claim 2, wherein selecting, based on at least one of the participants and the parameters of the remote online notarization session, the protocol to which the remote online notarization session will conform comprises:
querying a data structure that maps candidate values to candidate protocols for a matching candidate value;
identifying, based on the querying, a candidate protocol that matches the value; and
selecting the candidate protocol as the protocol to which the remote online notarization session will conform.

6. The method of claim 1, wherein the protocol corresponds to a technical requirement of a client device of the signer and of the notary during the remote online notarization session.

7. The method of claim 6, wherein the technical requirement is associated with a length of time, and wherein determining whether, during the remote online notarization session, the protocol was breached comprises determining whether the technical requirement was not met for at least its associated length of time.

8. The method of claim 1, wherein the protocol corresponds to an identity verification requirement of the signer.

9. The method of claim 8, wherein the protocol enables the notary to override the identity verification requirement.

10. The method of claim 1, wherein the participants include at least an additional signer, and wherein protocol indicates whether the additional signer must sign the envelope in a same remote online notarization session as the signer.

11. A non-transitory computer-readable medium comprising memory with instructions encoded thereon, the instructions, when executed by one or more processors, causing the one or more processors to perform operations, the instructions comprising instructions to:
receive a request to establish a remote online notarization session;
identify participants of the remote online notarization session, the participants including at least a signer and a notary;
identify an envelope to be notarized during the remote online notarization session;
determine, based on contents of the envelope, parameters of the remote online notarization session;
select, based on at least one of the participants and the parameters of the remote online notarization session, a protocol to which the remote online notarization session will conform;
establish the remote online notarization session using the protocol;
monitor the remote online notarization session;
based on the monitoring, determine whether, during the remote online notarization session, the protocol was breached by at least one of the signer and the notary prior to signature of the envelope by the signer and notarization;
responsive to determining that the protocol was breached, re-start the remote online notarization session; and
responsive to determining that the protocol was not breached, validate the remote online notarization session, and outputting a notarized version of the envelope.

12. The non-transitory computer-readable medium of claim 11, wherein the instructions to determine, based on the contents of the envelope, the parameters of the remote online notarization session comprise instructions to determine, from the contents of the envelope, a value associated with the envelope.

13. The non-transitory computer-readable medium of claim 12, wherein the instructions to determine the value associated with the envelope comprise instructions to extract the value from the contents.

14. The non-transitory computer-readable medium of claim 12, wherein the instructions to determine the value associated with the envelope comprise instructions to:
input at least a portion of the contents into a machine learning model; and
receive, as output from the machine learning model, the value.

15. The non-transitory computer-readable medium of claim 12, wherein the instructions to select, based on at least one of the participants and the parameters of the remote online notarization session, the protocol to which the remote online notarization session will conform comprise instructions to:
query a data structure that maps candidate values to candidate protocols for a matching candidate value;
identify, based on the querying, a candidate protocol that matches the value; and
select the candidate protocol as the protocol to which the remote online notarization session will conform.

16. The non-transitory computer-readable medium of claim 11, wherein the protocol corresponds to a technical requirement of a client device of the signer and of the notary during the remote online notarization session.

17. The non-transitory computer-readable medium of claim 16, wherein the technical requirement is associated with a length of time, and wherein the instructions to determine whether, during the remote online notarization session, the protocol was breached comprise instructions to determine whether the technical requirement was not met for at least its associated length of time.

18. The non-transitory computer-readable medium of claim 11, wherein the protocol corresponds to an identity verification requirement of the signer.

19. The non-transitory computer-readable medium of claim 18, wherein the protocol enables the notary to override the identity verification requirement.

20. A system comprising:
a non-transitory computer-readable medium comprising memory with instructions encoded thereon; and
one or more processors that, when executing the instructions, are caused to perform operations comprising:
receiving a request to establish a remote online notarization session;
identifying participants of the remote online notarization session, the participants including at least a signer and a notary;
identifying an envelope to be notarized during the remote online notarization session;
determining, based on contents of the envelope, parameters of the remote online notarization session;
selecting, based on at least one of the participants and the parameters of the remote online notarization session, a protocol to which the remote online notarization session will conform;
establishing the remote online notarization session using the protocol;
monitoring the remote online notarization session;
based on the monitoring, determining whether, during the remote online notarization session, the protocol was breached by at least one of the signer and the notary prior to signature of the envelope by the signer and notarization;
responsive to determining that the protocol was breached, re-starting the remote online notarization session; and
responsive to determining that the protocol was not breached, validating the remote online notarization session, and outputting a notarized version of the envelope.
